(19) United States
(12) Patent Application Publication
(10) Pub. No.: US 2024/0201476 A1
(43) Pub. Date: Jun. 20, 2024

(54) ZOOM LENS AND IMAGING APPARATUS

(71) Applicant: Tamron Co., Ltd., Saitama (JP)

(72) Inventor: Tomohiro KOBAYASHI, Saitama (JP)

(73) Assignee: Tamron Co., Ltd., Saitama (JP)

(21) Appl. No.: 18/526,820

(22) Filed: Dec. 1, 2023

(30) Foreign Application Priority Data
Dec. 20, 2022 (JP) 2022-203451

(51) Int. Cl. G02B 15/20

(52) U.S. Cl. CPC G02B 15/20

(57) ABSTRACT

A zoom lens has a plurality of lens groups and is a zoom lens that zooms from the wide-angle end to the telephoto end by changing the distance between adjacent lens groups, and has an aperture stop and at least one focus group each on the object side and the image side with the aperture stop therebetween, and when focused from infinity to a close object, the focus groups move along the optical axis, and the focus group arranged on the object side closer than the aperture stop includes at least one lens, and the lens satisfies the predetermined conditional expression. In addition, an imaging apparatus includes the zoom lens.

### CROSS-REFERENCE TO RELATED APPLICATIONS

This application is based on and claims the benefit of priority from Japanese Patent Application No. 2022-203451, filed on Dec. 20, 2022, the entire contents of which are incorporated herein by reference.

### BACKGROUND OF THE INVENTION

### Technical Field

This invention relates to a zoom lens and an imaging apparatus.

### Related Art

Conventionally, imaging apparatuses using solid-state image sensors, such as digital still cameras and digital video cameras, have been widely used. Such imaging apparatuses include, for example, digital still cameras, digital video cameras, broadcast cameras/film cameras, surveillance cameras, in-vehicle cameras, and many others. As the photodetectors that configure the solid-state image sensors become more integrated, all imaging apparatuses are becoming more sophisticated and compact, and the imaging optical systems of the imaging apparatuses are also required to be even more powerful and compact.

As imaging optical systems used in the imaging apparatuses, zoom lenses that can change the focal length according to the target object are in high demand. In zoom lenses, there is a need to increase the variable magnification ratio while suppressing the zoom lenses from becoming larger. In addition, zoom lenses with favorably corrected aberrations in the entire focus range are desired, and the use of a floating method in which a plurality of lens groups are moved during focusing is increasing.

As a zoom lens that performs focusing by such a floating method, for example, in JP 2020-118816A, an eight-group configuration zoom lens with the fourth lens group and the sixth lens group as a focus group and the fourth lens group composed of a single lens made of low-dispersion material is proposed. In addition, in JP 2017-129668A, a seven-group configuration zoom lens with the third lens group and the fifth lens group as a focus group and an aperture stop positioned between the third lens group and the fifth lens group is proposed.

In the zoom lens disclosed in JP 2020-118816A, the fourth lens group is arranged closer to the image side than the aperture stop. That is, both focus groups are arranged closer to the image side than the aperture stop. Therefore, when a wide angle is attempted in the same configuration as in JP 2020-118816A, it becomes difficult to correct chromatic aberration of magnification at a wide-angle end, and it becomes difficult to obtain excellent optical performance throughout the entire focus range. In addition, the aperture stop is far away from the image plane, resulting in a larger diameter rear ball, which makes the entire zoom lens larger.

On the other hand, in the zoom lens disclosed in JP 2017-129668A, the third lens group, which is a focus group arranged in front of the aperture stop, is made of a relatively high dispersion material with an Abbe constant of about 40. Therefore, when a wide angle is attempted in the same configuration as in JP 2017-129668A, it becomes difficult to correct chromatic aberration of magnification at the wide-angle end, and it becomes difficult to obtain excellent optical performance in the entire focus range.

Therefore, the problem to be solved by the present invention is to provide a zoom lens and an imaging apparatus that are compact and have excellent optical performance in the entire focus range while achieving a high variable magnification ratio.

### SUMMARY OF THE INVENTION

The zoom lens according to the present invention for solving the above problem has a plurality of lens groups and is a zoom lens that zooms from the wide-angle end to the telephoto end by changing the distance between adjacent lens groups, and has an aperture stop and at least one focus group each on the object side and the image side with the aperture stop therebetween, and when focused from infinity to a close object, the focus groups move along the optical axis, and the focus group Fa arranged on the object side closer than the aperture stop includes at least one lens La, and the lens La satisfies the following conditional expression:

$$va > 60 \qquad ( 1 )$$

here,
νa is Abbe constant relative to the d-line of the material forming the lens La.

In addition, in order to solve the above problem, the imaging apparatus according to the present invention has the zoom lens described above and an imaging device that converts an optical image formed by the zoom lens into an electrical signal.

### Effect of the Invention

According to the present invention, it is possible to provide a zoom lens and an imaging apparatus that are compact and have excellent optical performance in the entire focus range while achieving a high magnification ratio.

### BRIEF DESCRIPTION OF THE DRAWINGS

FIG. 1 is a cross-sectional view of a zoom lens of Example 1;

FIG. 2 is a diagram of aberrations of the zoom lens of Example 1 when focused at infinity at the wide-angle end;

FIG. 3 is a diagram of aberrations of the zoom lens of Example 1 when focused at infinity at the intermediate focal position;

FIG. 4 is a diagram of aberrations of the zoom lens of Example 1 when focused at infinity at the telephoto end;

FIG. 5 is a diagram of aberrations of the zoom lens of Example 1 when focused on a close object at the wide-angle end;

FIG. 6 is a diagram of aberrations of the zoom lens of Example 1 when focused on a close object at the intermediate focal position;

FIG. 7 is a diagram of aberrations of the zoom lens of Example 1 when focused on a close object at the telephoto end;

FIG. 8 is a cross-sectional view of a zoom lens of Example 2;

FIG. 9 is a diagram of aberrations of the zoom lens of Example 2 when focused at infinity at the wide-angle end;

FIG. 10 is a diagram of aberrations of the zoom lens of Example 2 when focused at infinity at the intermediate focal position;

FIG. 11 is a diagram of aberrations of the zoom lens of Example 2 when focused at infinity at the telephoto end;

FIG. 12 is a diagram of aberrations of the zoom lens of Example 2 when focused on a close object at the wide-angle end;

FIG. 13 is a diagram of aberrations of the zoom lens of Example 2 when focused on a close object at the intermediate focal position;

FIG. 14 is a diagram of aberrations of the zoom lens of Example 2 when focused on a close object at the telephoto end;

FIG. 15 is a cross-sectional view of a zoom lens of Example 3;

FIG. 16 is a diagram of aberrations of the zoom lens of Example 3 when focused at infinity at the wide-angle end;

FIG. 17 is a diagram of aberrations of the zoom lens of Example 3 when focused at infinity at the intermediate focal position;

FIG. 18 is a diagram of aberrations of the zoom lens of Example 3 when focused at infinity at the telephoto end;

FIG. 19 is a diagram of aberrations of the zoom lens of Example 3 when focused on a close object at the wide-angle end;

FIG. 20 is a diagram of aberrations of the zoom lens of Example 3 when focused on a close object at the intermediate focal position;

FIG. 21 is a diagram of aberrations of the zoom lens of Example 3 when focused on a close object at the telephoto end; and

FIG. 22 is a schematic diagram of one example of the configuration of an imaging apparatus according to one embodiment of the invention.

### DESCRIPTION OF THE EMBODIMENTS

The following is a description of the zoom lens and the imaging apparatus according to the present invention. However, the zoom lens and the imaging apparatus described below are only one aspect of the zoom lens and the imaging apparatus according to the present invention, and the zoom lens and the imaging apparatus according to the present invention are not limited to the following aspects.

### 1. Zoom Lens

### 1-1. Optical Configuration

The zoom lens has a plurality of lens groups and is a zoom lens that zooms from the wide-angle end to the telephoto end by changing the distance between adjacent lens groups, and has an aperture stop and at least one focus group each on the object side and the image side with the aperture stop therebetween.

According to the zoom lens, it is possible to obtain a zoom lens having excellent optical performance by providing a plurality of lens groups and changing the distance between the lens groups to achieve a high magnification ratio and to correct aberrations favorably in the entire zoom range. In this case, the zoom lens can perform focusing using the so-called floating method by arranging at least one focus group on the object side and one focus group on the image side of the aperture stop, respectively. Therefore, it is easy to suppress aberration fluctuation during focusing while maintaining a high magnification ratio. Furthermore, by arranging focus groups on both sides of the aperture stop, it is possible to suppress the position of the aperture stop from becoming too far from the image plane, and to suppress the rear ball diameter from becoming larger when a wide angle is attempted. As a result, it is possible to achieve a zoom lens that is compact and has excellent optical performance in the entire focus range while achieving a high magnification ratio.

The number of lens groups and the refractive power arrangement of the lens groups that configure the zoom lens are not particularly limited. As long as at least one focus group is arranged in front of and behind the aperture stop, other optical configurations are not particularly limited. However, as the number of lens groups that configure the zoom lens increases, it becomes difficult to make the zoom lens compact. On the other hand, when the number of lens groups that configure the zoom lens is reduced, it becomes difficult to achieve both high magnification ratio and excellent optical performance. From this viewpoint, the number of lens groups that configure the zoom lens is preferably eight or less, and more preferably seven or less. The number of lens groups that configure the zoom lens is preferably three or more, and more preferably four or more. The zoom lens also preferably has the following lens groups.

However, a lens group refers to a collection of one or more lenses that simultaneously move or remain stationary when zooming. That is, a lens group may be configured by a single lens, or may be configured by a plurality of lenses. The lens group may also include an aperture stop. In the zoom lens of the present invention, the distance between adjacent lens groups changes when zooming. The same is applied to the zoom lens in the examples described below.

### (1) Lens Group Closest to the Object Side

The lens group arranged nearest the object side (hereinafter referred to as the “lens group closest to the object side”) in the zoom lens may have a positive refractive power or a negative refractive power. When the lens group closest to the object side has a positive refractive power, the zoom lens becomes a so-called positive lead type zoom lens, and the configuration is more advantageous in obtaining a high magnification ratio. When the lens group closest to the object side has a negative refractive power, the zoom lens becomes a so-called negative lead type zoom lens, and the configuration is more advantageous in obtaining a wide angle. In such a zoom lens, the lens group closest to the object side preferably has a positive refractive power in order to achieve a higher magnification ratio.

Although there is no limit to the number of lenses that configure the lens group closest to the object side, it is preferable that the lens group closest to the object side is configured by three or fewer lenses in order to reduce the size and the weight of the zoom lens.

### (2) Focus Group Fa

By arranging the focus group Fa on the object side closer than the aperture stop, it is possible to effectively suppress aberration fluctuation during focusing together with the focus group arranged on the image side closer than the aperture stop, and to obtain excellent optical performance in the entire focus range. The focus group Fa may be all or a part of any of the lens groups (zoom groups) that configure the zoom lens, but it is preferred to arrange the focus group Fa on the image side closer than the lens group closest to the object side above and on the object side closer than the aperture stop.

The focus group Fa may have a positive refractive power or a negative refractive power, and a negative refractive power is preferred. By making the focus group Fa have a refractive power, it is easier to achieve a zoom lens that is compact and has excellent optical performance in the entire focus range while achieving a high magnification ratio.

Here, the focus group Fa includes at least one lens, and at least one lens La made of low-dispersion material that satisfies the conditional expression (1) to be described below. Here, conditional expression (1) is described below. By using such a lens La to configure the focus group arranged on the object side closer than the aperture stop, it is possible to favorably correct chromatic aberration of magnification at the wide-angle end even when a wide angle is attempted while achieving a high magnification ratio, and it is easier to achieve a zoom lens that has high optical performance in the entire zoom range and in the entire focus range. The lens La preferably has a negative refractive power. The lens La preferably also has a divergent surface on the object side. In addition, the lens La is preferably arranged closest to the object side in the focus group Fa. By adopting these configurations while satisfying the following conditional expression (1), the chromatic aberration of magnification at the wide-angle end and the longitudinal chromatic aberration at the telephoto end can be favorably corrected in a well-balanced manner, respectively.

The number of lenses that configure the focus group Fa is not particularly limited, and the focus group Fa may be configured by only the lens La or a plurality of lenses including the lens La, and it is preferable that the focus group Fa be configured by two or fewer lenses. By configuring the focus group Fa with two or fewer lenses, it is possible to reduce the size and the weight of the focus group. Therefore, the drive mechanism such as an actuator to move the focus group in the optical axis direction can be suppressed from becoming larger, and the entire zoom lens including the lens-barrel portion can be made more compact.

When the focus group Fa includes two or more lenses, one of the lenses preferably has a refractive power with a different sign from that of the above lens La. The lenses may be arranged with air spacing, or may include a joint lens where two or more lenses are joined together. It is more preferable to correct aberrations during focusing when air spacing exists between the lenses that configure the focus group Fa. When the focus group Fa includes a joint lens, assembly errors can be suppressed even when the focus sensitivity is high. Here, a single lens in the present invention means one single lens component. Therefore, as described above, with regard to a joint lens in which two or more lenses (two or more single lens components) are joined together, each single lens component that forms the joint lens is counted as a single lens.

In the zoom lens, there may be two or more focus groups arranged on the object side closer than the aperture stop, and it is preferable that only the focus group Fa is arranged on the object side closer than the aperture stop in order to suppress, for example, the drive mechanism from becoming larger.

### (3) Positive Lens Group P

The zoom lens preferably has a lens group having a positive refractive power together with the aperture stop arranged. The lens group is referred to as the positive lens group P in the present invention. The aperture stop is arranged, for example, on the object side or the image side of the positive lens group P, or within the positive lens group P, and moves with the positive lens group P along the optical axis during zooming, or is fixed relative to the image plane.

### (4) Image Side Focus Group

The focus group arranged on the image side of the aperture stop (referred to here as the “image side focus group”) is configured by the lens group that forms the zoom lens, or configured by a part thereof. The image side focus group includes at least one lens. From the viewpoint of making the focus group compact and lightweight, it is preferable that the image side focus group is also configured by two or fewer lenses.

The image side focus group is not limited as long as the image side focus group is arranged on the image side closer than the aperture stop, and may have a positive refractive power or a negative refractive power. By arranging the focus groups in front of and behind the aperture stop and setting the refractive power of each focus group to a different sign, it is possible to better suppress aberration fluctuation during focusing.

When the zoom lens has the positive lens group P, the image side focus group is preferably arranged on the image side closer than the positive lens group P. Since the light beam converged by the positive lens group P can be incident to the image side focus group, the fluctuation depending on the zoom position of the light beam diameter incident to the image side focus group can be suppressed, and aberration fluctuation during focusing can be suppressed.

Although two or more image side focus groups may be provided in the zoom lens, it is preferable to have only one image side focus group in order to suppress, for example, the drive mechanism from becoming larger.

### 1-2. Operation During Zooming

In the zoom lens, each lens group can be a movable group that moves with respect to the image plane or a fixed group that is fixed with respect to the image plane, as long as the distance along the optical axis between adjacent lens groups changes during zooming. In a case where all the lens groups are movable, it is preferable to correct aberrations since the position of each lens group can be changed respectively when zooming from the wide-angle end to the telephoto end. However, in order to move the lens group along the optical axis, a drive mechanism such as an actuator or motor is required, which increases the size of the entire zoom lens including the lens-barrel portion. From these points of view, each lens group may be selected as a movable or fixed group, as appropriate. The lens group closest to the object side and the positive lens group P are preferably moved as follows during zooming.

### (1) Lens Group Closest to the Object Side

The lens group closest to the object side may be a fixed group, but may be preferably a movable group, and it is particularly preferable to make the lens group closest to the object to move to the object side when zooming from the wide-angle end to the telephoto end. By moving the lens group closest to the object side to the object side, the total optical length at the wide-angle end becomes shorter than the total optical length at the telephoto end, and the zoom lens can be compactly housed when not in use by making the lens-barrel nested so that it can be ejected to the object side during zooming. It is also easier to achieve a higher magnification ratio by moving the lens group closest to the object to the object side. However, in this case, it is preferable to arrange a positive refractive power at the lens group closest to the object side in order to obtain a high magnification ratio.

### (2) Positive Lens Group P

When the zoom lens includes a positive lens group P, the positive lens group P may be a fixed group, but may be preferably a movable group, and it is particularly preferable to make the positive lens group P to move to the object side when zooming from the wide-angle end to the telephoto end. By moving the positive lens group P to the object side, the aperture stop is simultaneously moved, thereby preventing the front ball diameter from becoming larger when a wide angle is attempted.

### 1-3. Operation During Zooming

The direction of movement of each focus group during focusing is not limited, but when focusing from an infinity object to a near object, the focus group Fa and the image side focus group are preferably moved to the image side respectively. It is preferable to move the focus group Fa and the image side focus group respectively by different amounts, but they may be moved by the same amount.

### 1-4. Conditional Expression

The zoom lens preferably adopts the configuration described above and also satisfies at least one or more of the conditional expressions described below.

### 1-4-1. Conditional Expression (1)

$$va > 60 \qquad ( 1 )$$

here,
νa is Abbe constant relative to the d-line of the material forming the lens La.

The conditional expression (1) is an expression that specifies the Abbe constant relative to the d-line of the material forming the lens La. Higher magnification ratio tends to increase chromatic aberration of magnification at the wide-angle end and longitudinal chromatic aberration at the telephoto end. However, by including the lens La satisfying the conditional expression (1) in the focus group Fa, arranged on the object side closer to the aperture stop, the chromatic aberration of magnification at the wide-angle end can be favorably corrected, while the longitudinal chromatic aberration at the telephoto end can also be favorably corrected.

On the other hand, when no lens La satisfying the conditional expression (1) is included in the focus group Fa, in a case where the magnification ratio is made high, it becomes difficult to correct both in a balanced manner, for example, the longitudinal chromatic aberration at the telephoto end is increased when the chromatic aberration of magnification at the wide-angle end is attempted to be favorably corrected, and the chromatic aberration of magnification at the wide-angle end is increased when the longitudinal chromatic aberration at the telephoto end is attempted to be favorably corrected.

The lower limit of the conditional expression (1) is more preferable to be 65, and even more preferable to be 70 in order to obtain the effect. Note that when the preferred lower limit is adopted, inequality (<) may be replaced by inequality with an equal sign (≤) in the conditional expression (1). The same is applied to the conditional expression (2) described next, not only to the lower limit but also to the upper limit.

### 1-4-2. Conditional Expression (2)

$$0.1 < Ts / Ta < 0.9 \qquad ( 2 )$$

here,
Ts is Distance on the optical axis from the aperture stop to the image plane,
Ta is Total optical length of the zoom lens at the wide-angle end.

The conditional expression (2) is an expression that defines the ratio of the distance on the optical axis from the aperture stop to the image plane to the total optical length of the zoom lens at the wide-angle end. By satisfying the conditional expression (2), the aperture stop position becomes appropriate, and it becomes easy to prevent the front ball diameter and the rear ball diameter from increasing while suppressing aberration fluctuation during focusing by the focus groups arranged on both sides of the aperture stop, and it becomes easy to obtain a compact zoom lens while achieving excellent optical performance.

On the other hand, it is not preferable that the value of conditional expression (2) is equal to or less than the lower limit, because the position of the aperture stop becomes too close to the image plane and the front ball diameter becomes larger. On the other hand, it is not preferable that the value of conditional expression (2) is equal to or greater than the upper limit, because the position of the aperture stop is too far from the image plane and the rear ball diameter becomes larger. In both cases where the value of conditional expression (2) is equal to or less than the lower limit and the value of conditional expression (2) is equal to or greater than the upper limit, it becomes difficult to arrange a drive mechanism such as an actuator to move the focus groups arranged on both sides of the aperture stop inside the lens-barrel, and the diameter of the lens-barrel is required to be larger, resulting in the enlargement of the entire zoom lens including the lens-barrel portion.

The lower limit of the conditional expression (2) is more preferable to be 0.2, and even more preferable to be 0.4 in order to obtain the effect. The upper limit of the conditional expression (2) is more preferably to be 0.8, and even more preferably to be 0.6.

### 2. Imaging Apparatus

Next, the imaging apparatus according to the present invention will be described. The imaging apparatus according to the present invention includes the zoom lens according to the present invention and an imaging device that converts an optical image formed by the zoom lens into an electrical signal. Note that the imaging device is preferably provided on the image side of the zoom lens. There is no particular limitation on the imaging device, or the like, and solid-state image sensors such as a charge coupled device (CCD) sensor or a complementary metal oxide semiconductor (CMOS) sensor can also be used. The imaging apparatus according to the present invention is suitable for various imaging apparatus using these solid-state image sensors, such as digital video cameras, broadcast cameras/film cameras, surveillance cameras, and in-vehicle cameras. These imaging apparatuses may be lens-fixed imaging apparatuses in which the lenses are fixed to a housing, or may be lens-interchangeable imaging apparatuses.

FIG. 22 is a schematic diagram of one example of the configuration of the imaging apparatus. The imaging apparatus 1 has an imaging apparatus main body 2, a lens-barrel 3 attached to the imaging apparatus main body 2, an imaging device 21 arranged on the image side of the zoom lens, and a cover glass 22. The lens-barrel 3 houses the zoom lens according to the present invention, the aperture stop 31 and the drive mechanism for driving the lens group during zooming and focusing.

Next, examples are given to illustrate the present invention in detail. However, the present invention is not limited to the following examples.

### Example 1

### (1) Optical Configuration

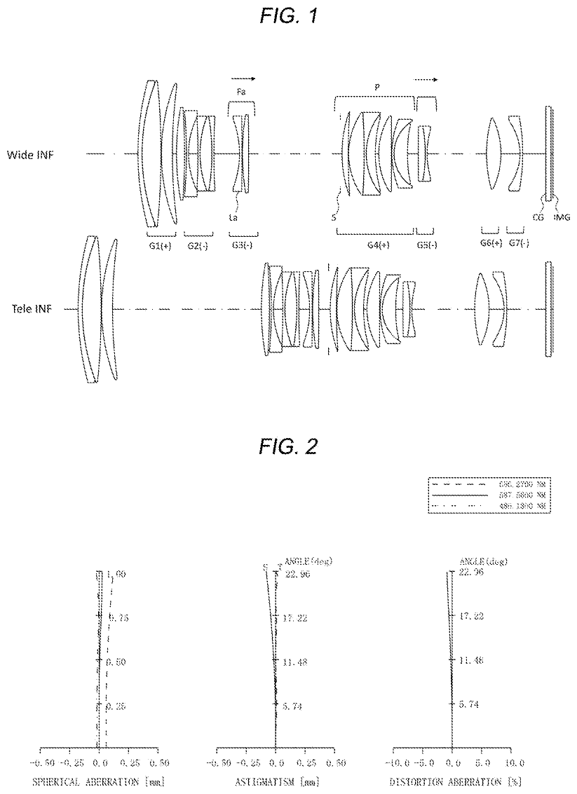

FIG. 1 is a cross sectional view of the zoom lens of Example 1 according to the present invention at the wide-angle end when focused at infinity. The zoom lens has a plurality of lens groups G1 to G7, and zooms from the wide-angle end to the telephoto end by changing the distance between adjacent lens groups. The zoom lens has one focus group Fa on the object side and one focus group on the image side with the aperture stop S therebetween.

Three lens groups G1 to G3 are arranged on the object side of the aperture stop S. The lens group closest to the object side G1 (first lens group) which is arranged closest to the object side in the zoom lens has a positive refractive power, and on the image side of the lens group closest to the object side, a lens group G2 (second lens group) having a negative refractive power and a focus group Fa (third lens group G3) are arranged in order from the object side. The focus group Fa has a negative refractive power, and includes the lens La which is a negative meniscus lens having a divergent surface on the side closest to the object side of the focus group Fa, and a positive lens is arranged on the image side of the lens La.

The image side of the aperture stop S has four lens groups starting from the object side, which are a positive lens group P (fourth lens group G4) having a positive refractive power and including the aperture stop S, an image side focus group G5 (fifth lens group) having a negative refractive power, a lens group G6 (sixth lens group) having a positive refractive power and including only one positive lens, and a lens group closest to the image side G7 (seventh lens group) having a negative refractive power and including a negative meniscus lens having a divergent surface on the object side. The particular lens configuration of each lens group is shown in the diagram, and the description is omitted.

When zooming from the wide-angle end to the telephoto end, among the three lens groups arranged on the object side of the aperture stop S, the lens group closest to the object side G1 moves to the object side, and the two lens groups G2 and G3, including the focus group Fa, move to the image side. The lens groups G4 to G7, which are arranged on the image side of aperture stop S, are all moved to the object side.

When focusing from infinity to a close object, both focus groups Fa and G5 move to the image side along the optical axis.

Note that in FIG. 1, “IMG” refers to the image plane, and specifically indicates the image plane of an imaging device such as a CCD sensor or CMOS sensor, or the film surface of a silver halide film, or the like. This point is the same for cross-sectional views of each lens shown in the other examples, and therefore the description will be omitted hereafter.

### (2) Numerical Embodiment

The following is a numerical embodiment of the application of specific numerical values for the zoom lens. The following shows “surface data”, “aspheric data”, “variation data (when focused at infinity)”, and “variation data (when focused at finite distance)”. The corresponding values for each conditional expression are shown in Table 1. Table 1 is shown after Example 3.

In “surface data”, “No.” is the order of lens surfaces counted from the object side, “R” is the curvature radius of the lens surface, “D” is the lens wall thickness or air spacing in the optical axis, “Nd” is the refractive index in the d-line (wavelength λ=587.5618 nm), and “ABV” is the Abbe constant relative to the d-line. In the “No.” column, “ASPH” following the surface number indicates that the surface is aspherical, and “STOP” indicates that it is an aperture stop. In the “D” column, “(d5)”, or the like, indicates that the distance on the optical axis of the lens surface is a variable distance that changes when focusing. In addition, “∞” in the curvature radius column indicates infinity, which indicates that the surface is flat.

The “aspheric data” shows the value of each coefficient when the aspheric surface is defined by the following equation:

$$z = {ch}^{2} / [ 1 + {\{ 1 - ( 1 + K ) {c}^{2} {h}^{2} \}}^{1 / 2} ] + A 4 {h}^{4} + A 6 {h}^{6} + A 8 {h}^{8} + A 10 {h}^{10} + A 12 {h}^{12}$$

here, c is the curvature (1/r), h is the height from the optical axis, K is the cone coefficient, A4, A6, A8, A10, and A12 are the aspherical coefficients for each order.

The “variation data (when focused at infinity)” shows the various data when focused at infinity, “Fno” is the F number, “ω” is the half angle of view, and “d5” or the like is each variable distance shown in the surface data, and the respective values at the wide-angle end, the intermediate focal position, and the telephoto end are shown.

The “variation data (when focused at finite distance)” shows each variable distance when focused at finite distance (specified imaging distance), and the respective values at the wide-angle end, the intermediate focal position, and the telephoto end are shown.

The matters in each of these tables are the same for each of the tables shown in the other examples, so the descriptions are omitted hereafter.

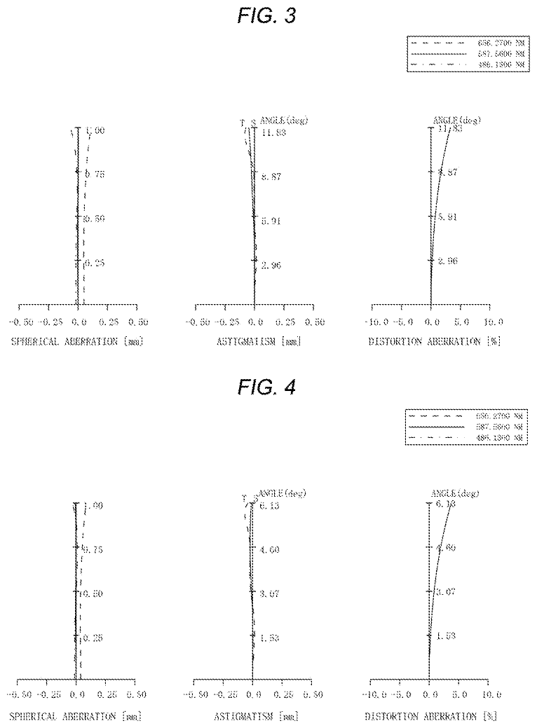

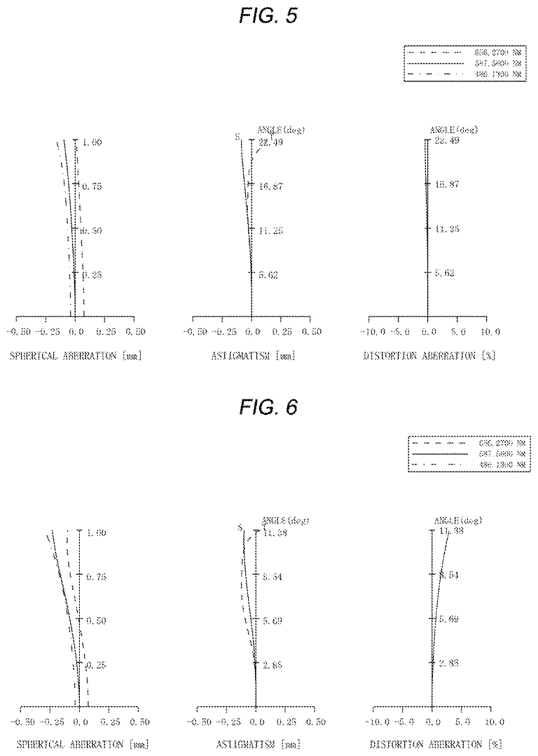

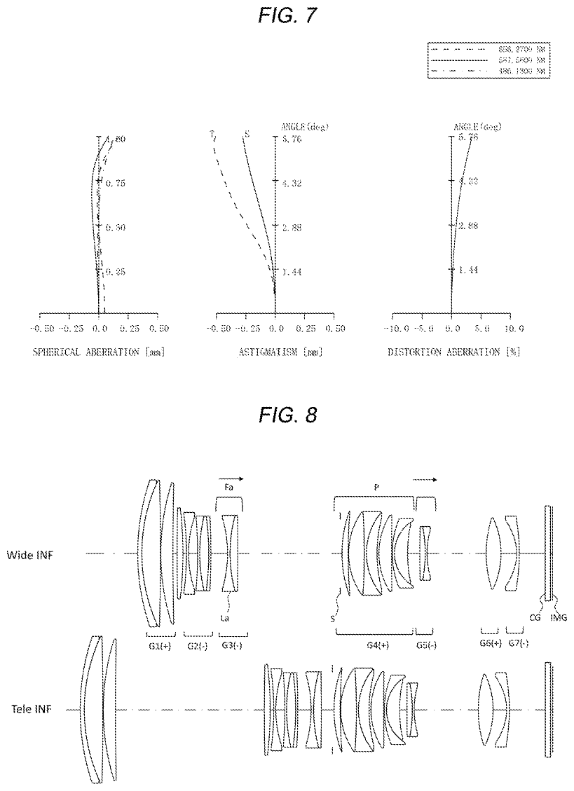

FIGS. 2 to 4 show the longitudinal aberration diagrams at the wide-angle end, the intermediate focal position, and the telephoto end of the zoom lens when focused at infinity, respectively, and FIGS. 5 to 7 show the longitudinal aberration diagrams at the wide-angle end, the intermediate focal position, and the telephoto end of the zoom lens when focused at infinity, respectively. The longitudinal aberration diagrams shown in each diagram are, from left to right, spherical aberration (mm), astigmatism (mm), and distortion aberration (s). The spherical aberration diagram shows the characteristics of the dashed line for the C line (wavelength 656.2700 nm), the solid line for the d line (wavelength 587.5600 nm), and the single-dotted chain line for the F line (wavelength 486.1300 nm). In the astigmatism diagram, the vertical axis is the half-angle (ω) and the horizontal axis is the defocus, and the solid line shows the sagittal image plane of the d-line (indicated by S in the diagram), and the dashed line shows the meridional image plane of the d-line (indicated by T in the diagram), respectively. In the distortion aberration diagram, the vertical axis is the half-angle (ω) and the horizontal axis is the distortion aberration. These matters are the same for each of the aberration diagrams shown in the other examples, so the descriptions are omitted hereafter.

| No. | R | D | Nd | ABV |
|---|---|---|---|---|
| 1 | 133.0288 | 2.0000 | 1.90366 | 31.31 |
| 2 | 96.2695 | 9.1066 | 1.43700 | 95.10 |
| 3 | −349.1188 | 0.2000 | | |
| 4 | 91.4877 | 5.2643 | 1.43700 | 95.10 |
| 5 | 247.3711 | (d5) | | |
| 6 | 126.0655 | 3.8839 | 1.90110 | 27.06 |
| 7 | −327.8015 | 0.9259 | | |
| 8 | −220.4940 | 1.0000 | 2.00069 | 25.46 |
| 9 | 40.8285 | 4.5387 | | |
| 10 | −318.3667 | 1.0000 | 1.76506 | 34.95 |
| 11 | 49.8633 | 5.6972 | 1.92643 | 21.91 |
| 12 | −106.8134 | 1.0000 | 1.78061 | 44.91 |
| 13 | 376.2041 | (d13) | | |
| 14 | −46.4446 | 1.2000 | 1.58951 | 63.58 |
| 15 | −1306.9477 | 0.2000 | | |
| 16 | 114.7778 | 2.9911 | 1.85986 | 25.26 |
| 17 | −1011.2224 | (d17) | | |
| 18STOP | ∞ | 0.8000 | | |
| 19 | 60.1664 | 3.0000 | 1.86407 | 34.78 |
| 20 | 296.6660 | 0.2000 | | |
| 21 | 35.3516 | 7.4774 | 1.49769 | 81.40 |
| 22 | −306.5071 | 1.0000 | 1.85761 | 28.29 |
| 23 | 31.0704 | 4.3917 | 1.49825 | 81.24 |
| 24 | 65.9327 | 1.6424 | | |
| 25 | 35.0409 | 6.0622 | 1.77047 | 29.74 |
| 26 | 5258.0562 | 0.2397 | | |
| 27 | 44.3685 | 1.0636 | 1.80610 | 33.27 |
| 28 | 18.4438 | 6.4902 | 1.49710 | 81.56 |
| 29ASPH | 96.2072 | (d29) | | |
| 30 | 829.3701 | 3.3667 | 1.92119 | 23.96 |
| 31 | −72.6480 | 0.9000 | 1.74320 | 49.34 |
| 32 | 42.0231 | (d32) | | |
| 33 | 63.7357 | 6.9587 | 1.51680 | 64.20 |
| 34 | −39.5462 | (d34) | | |
| 35ASPH | −24.3046 | 1.3000 | 1.85108 | 40.12 |
| 36ASPH | −98.1396 | (d36) | | |
| 37 | ∞ | 2.5000 | 1.51680 | 64.20 |
| 38 | ∞ | 1.0000 | | |

### [Aspheric Data]

| No. | K | A4 | A6 | A8 | A10 | A12 |
|---|---|---|---|---|---|---|
| 29 | 0 | 1.05216E−05 | 7.88990E−09 | 9.32258E−12 | 4.02110E−14 | 9.23355E−17 |
| 35 | 0 | −6.35691E−07 | 1.03143E−07 | −4.21064E−10 | 9.61588E−13 | −8.35481E−17 |
| 36 | 0 | −8.28356E−06 | 7.79522E−08 | −3.14763E−10 | 6.33345E−13 | −5.08439E−17 |

[Variation Data (when Focused at Infinity)]

| | Wide-angle | Intermediate | Telephoto |
|---|---|---|---|
| Focal | 51.5015 | 99.9998 | 192.9993 |
| length | | | |
| Fno | 2.9100 | 2.9100 | 2.9100 |
| ω | 22.9584 | 11.8287 | 6.1335 |
| d 5 | 2.0000 | 38.3417 | 71.7058 |
| d13 | 12.3084 | 7.4788 | 5.2384 |
| d17 | 44.2080 | 23.1974 | 4.6996 |
| d29 | 5.1774 | 7.3579 | 3.5000 |
| d32 | 28.6122 | 26.4316 | 30.2896 |
| d34 | 9.1946 | 9.2335 | 7.2110 |
| d36 | 11.1000 | 15.7851 | 18.8052 |

[Variation Data (when Focused at Finite Distance)]

| Imaging distance | 1000 | 1000 | 1300 |
|---|---|---|---|
| d13 | 16.3411 | 10.7417 | 6.4380 |
| d17 | 40.1753 | 19.9344 | 3.5000 |
| d29 | 7.6690 | 14.4253 | 18.9341 |
| d32 | 26.1206 | 19.3643 | 14.8555 |

### Example 2

### (1) Optical Configuration

FIG. 8 is a cross sectional view of the zoom lens of Example 2 according to the present invention at the wide-angle end when focused at infinity. The zoom lens has a plurality of lens groups G1 to G7, and zooms from the wide-angle end to the telephoto end by changing the distance between adjacent lens groups. The zoom lens has one focus group Fa on the object side and one focus group on the image side with the aperture stop S therebetween.

Three lens groups G1 to G3 are arranged on the object side of the aperture stop S. The lens group closest to the object side G1 (first lens group) which is arranged closest to the object side in the zoom lens has a positive refractive power, and on the image side of the lens group closest to the object side, a lens group G2 (second lens group) having a negative refractive power and a focus group Fa (third lens group G3) are arranged in order from the object side. The focus group Fa has a negative refractive power, and includes the lens La which is a negative lens (biconcave lens) having divergent surfaces on both surfaces on the side closest to the object side of the focus group Fa, and the lens La is bonded to the positive lens.

The image side of the aperture stop S has four lens groups starting from the object side, which are a positive lens group P (fourth lens group G4) having a positive refractive power and including the aperture stop S, an image side focus group G5 (fifth lens group) having a negative refractive power, a lens group G6 (sixth lens group) having a positive refractive power and including only one positive lens, and a lens group closest to the image side G7 (seventh lens group) having a negative refractive power and including a negative meniscus lens having a divergent surface on the object side. The particular lens configuration of each lens group is shown in the diagram, and the description is omitted.

When zooming from the wide-angle end to the telephoto end, among the three lens groups arranged on the object side of the aperture stop S, the lens group closest to the object side G1 moves to the object side, and the two lens groups G2 and G3, including the focus group Fa, move to the image side. The lens groups G4 to G7, which are arranged on the image side of aperture stop S, are all moved to the object side.

When focusing from infinity to a close object, both focus groups Fa and G5 move to the image side along the optical axis.

### (2) Numerical Embodiment

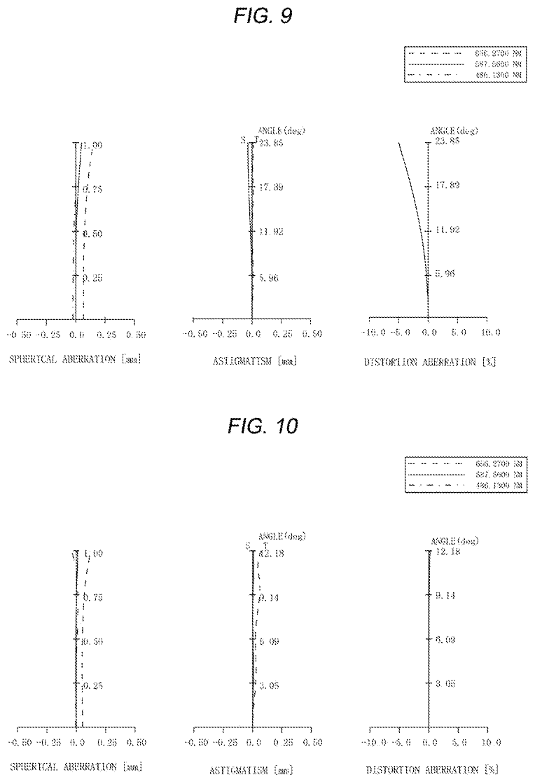

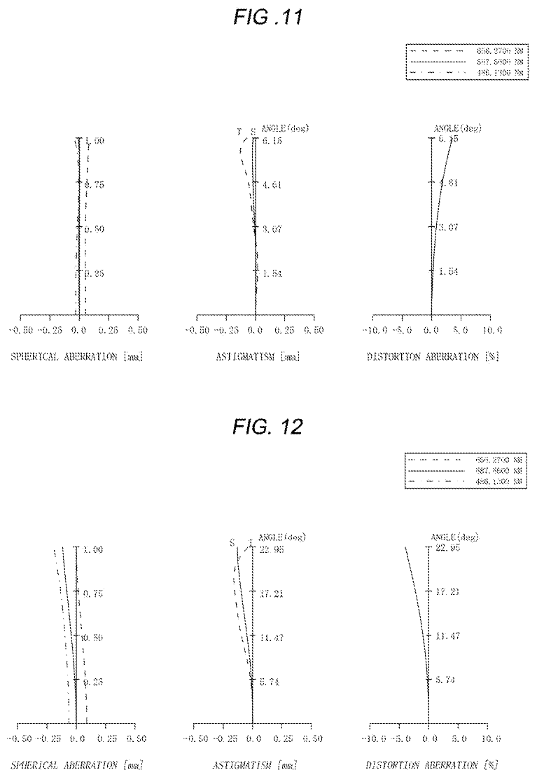

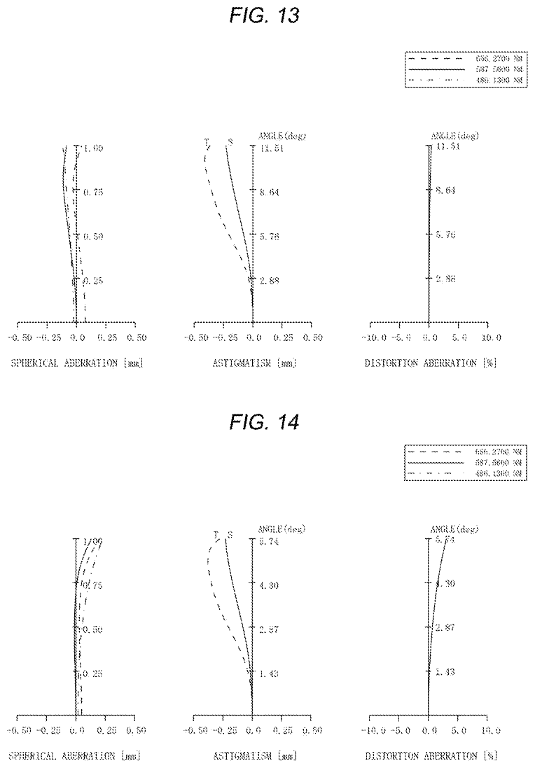

Next, the following is a numerical embodiment of the application of specific values for the zoom lens. The corresponding values for each conditional expression are shown in the following Table 1. FIGS. 9 to 11 show the longitudinal aberration diagrams at the wide-angle end, the intermediate focal position, and the telephoto end of the zoom lens when focused at infinity, respectively, and FIGS. 12 to 14 show the longitudinal aberration diagrams at the wide-angle end, the intermediate focal position, and the telephoto end of the zoom lens when focused at infinity, respectively.

### [Surface Data]

| No. | R | D | Nd | ABV |
|---|---|---|---|---|
| 1 | 110.2724 | 2.0000 | 1.90366 | 31.31 |
| 2 | 83.6373 | 8.9428 | 1.43700 | 95.10 |
| 3 | −1498.5900 | 0.2000 | | |
| 4 | 113.5110 | 5.8537 | 1.43700 | 95.10 |
| 5 | 1484.4475 | (d5) | | |
| 6 | 960.4682 | 2.7908 | 1.90110 | 27.06 |
| 7 | −188.0380 | 1.7184 | | |
| 8 | −141.4735 | 1.0000 | 2.00069 | 25.46 |
| 9 | 55.4023 | 4.3585 | | |
| 10 | −201.7889 | 1.0000 | 1.76869 | 49.80 |
| 11 | 78.4507 | 4.3850 | 1.92286 | 20.88 |
| 12 | −129.9408 | 1.0000 | 1.82418 | 39.62 |
| 13 | −364.7445 | (d13) | | |
| 14 | −59.8599 | 1.2000 | 1.58103 | 60.71 |
| 15 | 70.3331 | 3.6659 | 1.90366 | 31.31 |
| 16 | −2409.3139 | (d16) | | |
| 17STOP | ∞ | 0.8000 | | |
| 18 | 59.2221 | 3.0000 | 1.86271 | 34.92 |
| 19 | 251.0984 | 0.2000 | | |
| 20 | 34.8929 | 7.5742 | 1.49806 | 81.29 |
| 21 | −298.6902 | 1.0000 | 1.85779 | 28.75 |
| 22 | 31.0519 | 5.1114 | 1.49934 | 78.91 |
| 23 | 65.8351 | 0.9122 | | |
| 24 | 34.6956 | 6.1478 | 1.77047 | 29.74 |
| 25 | 2157.9603 | 0.2786 | | |
| 26 | 43.2577 | 1.0538 | 1.80610 | 33.27 |
| 27 | 18.2935 | 6.3640 | 1.49710 | 81.56 |
| 28ASPH | 88.8730 | (d28) | | |
| 29 | 801.0565 | 2.5819 | 1.92119 | 23.96 |
| 30 | −69.0243 | 0.9000 | 1.74320 | 49.34 |
| 31 | 41.8040 | (d31) | | |
| 32 | 56.5596 | 7.1467 | 1.51680 | 64.20 |
| 33 | −40.2114 | (d33) | | |
| 34ASPH | −24.1695 | 1.3000 | 1.85108 | 40.12 |
| 35ASPH | −100.4819 | (d35) | | |
| 36 | ∞ | 2.5000 | 1.51680 | 64.20 |
| 37 | ∞ | 1.0000 | | |

### [Aspheric Data]

| No. | K | A4 | A6 | A8 | A10 | A12 |
|---|---|---|---|---|---|---|
| 28 | 0 | 1.04508E−05 | 8.29492E−09 | 1.06901E−11 | 4.14662E−14 | 9.30080E−17 |
| 34 | 0 | 1.84389E−07 | 1.05065E−07 | −4.20367E−10 | 9.60849E−13 | −8.55606E−16 |
| 35 | 0 | −8.76883E−06 | 7.89457E−08 | −3.12890E−10 | 6.29699E−13 | −5.16796E−16 |

[Variation Data (when Focused at Infinity)]

| | Wide-angle | Intermediate | Telephoto |
|---|---|---|---|
| Focal length | 51.5000 | 99.9998 | 194.0000 |
| Fno | 2.9100 | 2.9100 | 2.9100 |
| ω | 23.8494 | 12.1803 | 6.1470 |
| d 5 | 2.0000 | 34.2578 | 71.7384 |
| d13 | 8.0382 | 3.8129 | 6.4407 |
| d16 | 49.6170 | 24.9735 | 5.3676 |
| d28 | 5.8719 | 8.1244 | 3.5000 |
| d31 | 28.4733 | 26.2208 | 30.8452 |
| d33 | 7.5167 | 8.7313 | 6.5207 |
| d35 | 12.4984 | 17.9411 | 17.3671 |

[Variation Data (when Focused at Finite Distance)]

| Imaging distance | 1000 | 1000 | 1300 |
|---|---|---|---|
| d13 | 17.8853 | 9.7720 | 8.3083 |
| d16 | 39.7698 | 19.0144 | 3.5000 |
| d28 | 9.7132 | 16.4756 | 20.2886 |
| d31 | 24.6320 | 17.8696 | 14.0566 |

### Example 3

### (1) Optical Configuration

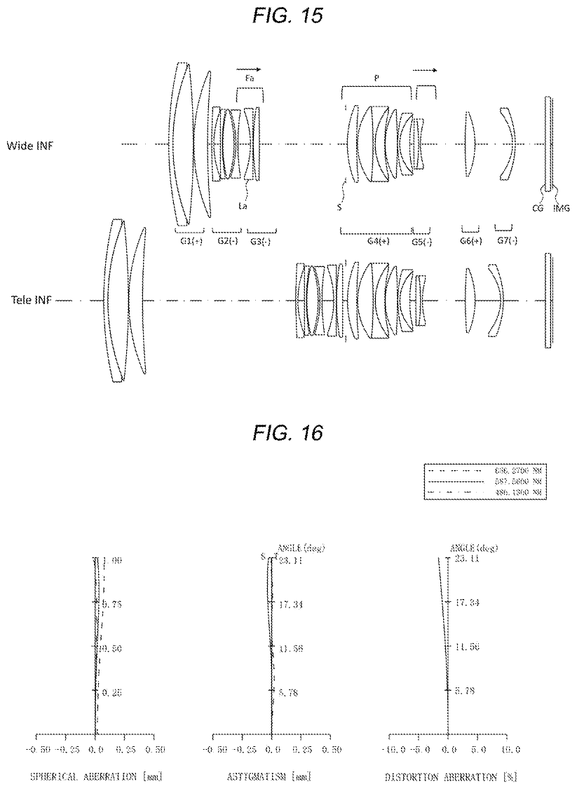

FIG. 15 is a cross sectional view of the zoom lens of Example 3 according to the present invention at the wide-angle end when focused at infinity. The zoom lens has a plurality of lens groups G1 to G7, and zooms from the wide-angle end to the telephoto end by changing the distance between adjacent lens groups. The zoom lens has one focus group Fa on the object side and one focus group on the image side with the aperture stop S therebetween.

Three lens groups G1 to G3 are arranged on the object side of the aperture stop S. The lens group closest to the object side G1 (first lens group) which is arranged closest to the object side in the zoom lens has a positive refractive power, and on the image side of the lens group closest to the object side, a lens group G2 (second lens group) having a negative refractive power and a focus group Fa (third lens group G3) are arranged in order from the object side. The focus group Fa has a negative refractive power, and includes the lens La which is a negative meniscus lens having a divergent surface on the side closest to the object side of the focus group Fa, and a positive lens is arranged on the image side of the lens La.

The image side of the aperture stop S has four lens groups starting from the object side, which are a positive lens group P (fourth lens group G4) having a positive refractive power and including the aperture stop S, an image side focus group G5 (fifth lens group) having a negative refractive power, a lens group G6 (sixth lens group) having a positive refractive power and including only one positive lens, and a lens group closest to the image side G7 (seventh lens group) having a negative refractive power and including a negative meniscus lens having a divergent surface on the object side. The particular lens configuration of each lens group is shown in the diagram, and the description is omitted.

When zooming from the wide-angle end to the telephoto end, among the three lens groups arranged on the object side of the aperture stop S, the lens group closest to the object side G1 moves to the object side, and the two lens groups G2 and G3, including the focus group Fa, move to the image side. The lens groups G4 to G7, which are arranged on the image side of aperture stop S, are all moved to the object side.

When focusing from infinity to a close object, both focus groups Fa and G5 move to the image side along the optical axis.

### (2) Numerical Embodiment

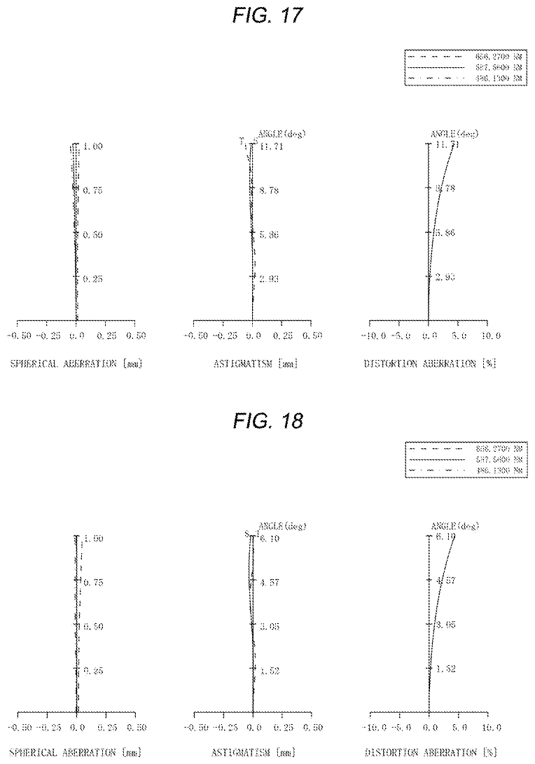

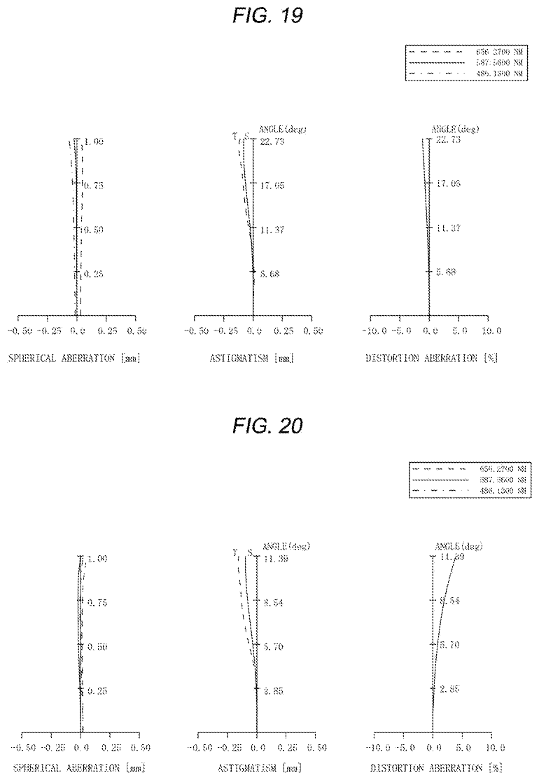

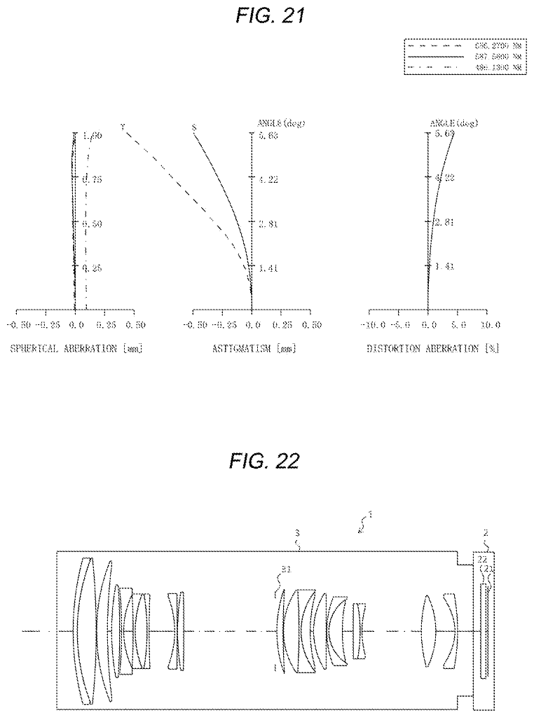

Next, the following is a numerical embodiment of the application of specific values for the zoom lens. The corresponding values for each conditional expression are shown in the following Table 1. FIGS. 16 to 18 show the longitudinal aberration diagrams at the wide-angle end, the intermediate focal position, and the telephoto end of the zoom lens when focused at infinity, respectively, and FIGS. 19 to 21 show the longitudinal aberration diagrams at the wide-angle end, the intermediate focal position, and the telephoto end of the zoom lens when focused at infinity, respectively.

### [Surface Data]

| No. | R | D | Nd | ABV |
|---|---|---|---|---|
| 1 | 174.9946 | 2.0000 | 1.80610 | 33.27 |
| 2 | 102.4447 | 9.8586 | 1.43700 | 95.10 |
| 3 | −357.7691 | 0.2000 | | |
| 4 | 87.8166 | 6.6440 | 1.49700 | 81.61 |
| 5 | 383.9713 | (d5) | | |
| 6 | 290.8586 | 1.0000 | 2.00100 | 29.13 |
| 7 | 42.9464 | 3.1046 | | |
| 8 | 1514.6773 | 1.0000 | 1.75500 | 52.32 |
| 9 | 92.7843 | 0.2000 | | |
| 10 | 71.1101 | 5.4634 | 1.80000 | 29.84 |
| 11 | −54.7031 | 0.8398 | | |
| 12 | −50.5513 | 1.0000 | 1.65100 | 56.24 |
| 13 | 107.2152 | (d13) | | |
| 14 | −43.5282 | 1.2000 | 1.49700 | 81.61 |
| 15 | 1774.9054 | 0.2000 | | |
| 16 | 109.7267 | 2.9186 | 1.84666 | 23.78 |
| 17 | −1234.2168 | (d17) | | |
| 18STOP | ∞ | 0.8000 | | |
| 19 | 48.6686 | 4.4632 | 1.71700 | 47.93 |
| 20 | 195.6443 | 0.4282 | | |
| 21 | 30.5507 | 7.4967 | 1.43700 | 95.10 |
| 22 | −194.2167 | 1.0000 | 1.85025 | 30.05 |
| 23 | 27.2948 | 4.6081 | 1.62004 | 36.26 |
| 24 | 67.2775 | 0.2000 | | |
| 25ASPH | 32.0034 | 5.8198 | 1.80610 | 40.73 |
| 26ASPH | −248.2766 | 0.2000 | | |
| 27 | 51.1416 | 1.0000 | 1.83400 | 37.21 |
| 28 | 19.1238 | 4.8049 | 1.49710 | 81.56 |
| 29ASPH | 73.0869 | (d29) | | |
| 30 | 466.9736 | 2.2685 | 1.92286 | 20.88 |
| 31 | −88.3142 | 0.9000 | 1.77250 | 49.60 |
| 32 | 38.3605 | (d32) | | |
| 33 | 208.8169 | 4.7070 | 1.49700 | 81.61 |
| 34 | −39.8811 | (d34) | | |
| 35ASPH | −20.6684 | 1.3000 | 1.77377 | 47.17 |
| 36ASPH | −40.5912 | (d36) | | |
| 37 | ∞ | 2.5000 | 1.51680 | 64.20 |
| 38 | ∞ | 1.0000 | | |

### [Aspheric Data]

| No. | K | A4 | A6 | A8 | A10 | A12 |
|---|---|---|---|---|---|---|
| 25 | 0 | −1.97210E−06 | 1.53875E−09 | −5.36682E−13 | 1.14007E−14 | 0.00000E+00 |
| 26 | 0 | 6.11842E−07 | 3.83941E−09 | −2.95846E−12 | 1.47430E−15 | 0.00000E+00 |
| 29 | 0 | 1.49954E−05 | 1.32332E−08 | 2.37621E−11 | 8.72191E−15 | 8.46004E−16 |
| 35 | 0 | 5.84605E−06 | 1.17250E−07 | −4.29479E−10 | 8.18571E−13 | −1.01409E−16 |
| 36 | 0 | −4.37657E−06 | 8.03907E−08 | −3.43893E−10 | 6.46644E−13 | −4.15174E−16 |

[Variation Data (when Focused at Infinity)]

| | Wide-angle | Intermediate | Telephoto |
|---|---|---|---|
| Focal | 51.4970 | 100.0108 | 194.0138 |
| length | | | |
| Fno | 2.9100 | 2.9100 | 2.9100 |
| ω | 23.1142 | 11.7116 | 6.0997 |
| d 5 | 2.0000 | 39.4666 | 73.9566 |
| d13 | 6.0050 | 8.9963 | 5.6465 |
| d17 | 41.7244 | 16.0178 | 1.5000 |
| d29 | 2.0018 | 7.9845 | 2.8916 |
| d32 | 21.5710 | 15.5884 | 20.6813 |
| d34 | 18.0716 | 15.3957 | 12.3015 |
| d36 | 14.5012 | 17.1775 | 20.2711 |

[Variation Data (when Focused at Finite Distance)]

| Imaging distance | 1000 | 1000 | 1000 |
|---|---|---|---|
| d13 | 8.5162 | 9.3512 | 5.7054 |
| d17 | 39.2132 | 15.6629 | 1.4411 |
| d29 | 3.6270 | 13.2804 | 20.5794 |
| d32 | 19.9459 | 10.2924 | 2.9935 |

TABLE 1

| Conditional expression | Example 1 | Example 2 | Example 3 |
|---|---|---|---|
| Conditional expression (1) νa | 63.58 | 60.71 | 81.63 |
| Conditional expression (2) Ts/Ta | 0.479 | 0.511 | 0.539 |

### SUMMARY

The zoom lens according to the first aspect of the present invention has a plurality of lens groups and is a zoom lens that zooms from the wide-angle end to the telephoto end by changing the distance between adjacent lens groups, and has an aperture stop and at least one focus group each on the object side and the image side with the aperture stop therebetween, and when focused from infinity to a close object, the focus groups move along the optical axis, and the focus group Fa arranged on the object side closer than the aperture stop includes at least one lens La, and the lens La satisfies the following conditional expression:

$$va > 60 \qquad ( 1 )$$

here,
νa is Abbe constant relative to the d-line of the material forming the lens La.

In the zoom lens according to the second aspect of the present invention, it is preferable that in the first aspect, the lens La is a lens having a negative refractive power.

In the zoom lens according to the third aspect of the present invention, it is preferable that in the first aspect or the second aspect, the lens La has a divergent surface on the object side.

In the zoom lens according to the fourth aspect of the present invention, it is preferable that in any aspect of the first aspect to the third aspect, the lens La is arranged closest to the object side in the focus group Fa.

In the zoom lens according to the fifth aspect of the present invention, it is preferable that in any aspect of the first aspect to the fourth aspect, the focus group Fa is configured by two or fewer lenses.

In the zoom lens according to the sixth aspect of the present invention, it is preferable that in any aspect of the first aspect to the fourth aspect, a lens group arranged closest to the object side has a positive refractive power.

In the zoom lens according to the seventh aspect of the present invention, it is preferable that in any aspect of the first aspect to the sixth aspect, a lens group arranged closest to the object side is configured by three or fewer lenses.

In the zoom lens according to the eighth aspect of the present invention, it is preferable that in any aspect of the first aspect to the seventh aspect, a lens group arranged closest to the object side moves to an object side when zooming from a wide-angle end to a telephoto end.

In the zoom lens according to the nineth aspect of the present invention, it is preferable that in any aspect of the first aspect to the eighth aspect, the following conditional expression is satisfied:

$$0.1 < Ts / Ta < 0.9 \qquad ( 2 )$$

here,
Ts is Distance on the optical axis from the aperture stop to the image plane,
Ta is Total optical length of the zoom lens at the wide-angle end.

In the zoom lens according to the tenth aspect of the present invention, it is preferable that in any aspect of the first aspect to the nineth aspect, the zoom lens includes a positive lens group P having a positive refractive power, in which the positive lens group P is adjacent to the aperture stop, or includes the aperture stop, and the positive lens group P moves toward an object side when zooming from a wide-angle end to a telephoto end in the same trajectory as the aperture stop.

The imaging apparatus according to the eleventh aspect of the present invention has a zoom lens of any aspect of the first aspect to the tenth aspect, and an imaging device that converts an optical image formed by the zoom lens on an image side of the zoom lens into an electrical signal.

### INDUSTRIAL APPLICABILITY

According to the present invention, it is possible to provide a zoom lens and an imaging apparatus that are compact and have excellent optical performance in the entire focus range while achieving a high magnification ratio.

1. A zoom lens including a plurality of lens groups and zooming from a wide-angle end to a telephoto end by changing a distance between adjacent lens groups, the zoom lens comprising:
an aperture stop; and
at least one focus group each on an object side and an image side with the aperture stop between the object side and the image side, wherein
when focused from infinity to a close object, each of the focus group moves along an optical axis, and a focus group Fa arranged on an object side closer than the aperture stop includes at least one lens La, and
the lens La satisfies a following conditional expression:
$$va > 60 \qquad ( 1 )$$
here,
va is Abbe constant relative to the d-line of the material forming the lens La.

2. The zoom lens according to claim 1, wherein
the lens La is a lens having a negative refractive power.

3. The zoom lens according to claim 1, wherein
the lens La has a divergent surface on an object side.

4. The zoom lens according to claim 1, wherein
the lens La is arranged closest to an object side in the focus group Fa.

5. The zoom lens according to claim 1,
wherein the focus group Fa is configured by two or fewer lenses.

6. The zoom lens according to claim 1, wherein
a lens group arranged closest to an object side has a positive refractive power.

7. The zoom lens according to claim 1,
wherein a lens group arranged closest to an object side is configured by three or fewer lenses.

8. The zoom lens according to claim 1, wherein
a lens group arranged closest to an object side moves to an object side when zooming from a wide-angle end to a telephoto end.

9. The zoom lens according to claim 1 satisfying a following conditional expression:
$$0.1 < Ts / Ta < 0.9 \qquad ( 2 )$$
here,
Ts is Distance on an optical axis from the aperture stop to an image plane.
Ta is Total optical length of the zoom lens at a wide-angle end.

10. The zoom lens according to claim 1 comprising:
a positive lens group P having a positive refractive power, wherein
the positive lens group P is adjacent to the aperture stop, or includes the aperture stop, and
the positive lens group P moves toward an object side when zooming from a wide-angle end to a telephoto end in a same trajectory as the aperture stop.

11. An imaging apparatus comprising:
the zoom lens according to claim 1; and
an imaging device that converts an optical image formed by the zoom lens on an image side of the zoom lens into an electrical signal.
